(19) United States
(12) Patent Application Publication
(10) Pub. No.: US 2005/0123319 A1
(43) Pub. Date: Jun. 9, 2005

(54) Image forming apparatus and process cartridge for the same

(75) Inventor: Yoshihiro Mizoguchi, Fukuoka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 10/984,969

(22) Filed: Nov. 10, 2004

(30) Foreign Application Priority Data
Nov. 10, 2003 (JP) P. 2003-379747

(51) Int. Cl. G03G 21/18

(52) U.S. Cl. 399/111

(57) ABSTRACT

An image forming apparatus having a process cartridge that includes a first protective member which is attached to one end in the longitudinal direction of the process cartridge and holds a photoconductor drum 2a and a development roller 2b spacially, and a second protective member which is attached to a rotational shaft end of the photoconductor drum 2a and prevents rotation of the photoconductor drum 2a.

### BACKGROUND OF THE INVENTION

The present invention relates to an image forming apparatus and a process cartridge removably attached to a main body of an electrophotographic image forming apparatus, and particularly to a protective member used in conveyance and storage of a process cartridge.

Heretofore, in an image forming apparatus which adopts electrophotography, a photoconductor that is an image bearing member has been charged by a charger, light irradiation according to image data has been performed on the charged photoconductor thereby to form a latent image, this latent image has been developed by a developing device, and the developed toner image has been transferred onto a recording medium, whereby an image has been formed.

On the other hand, with colorization of an image, a tandem type color image forming apparatus has been also proposed, which has plural process cartridges in which each of the above image forming processes is executed, forms a toner image of each color of cyan, magenta, yellow, and preferably black on each photoconductor, and multi-layer transfers these toner images onto an endless intermediate transfer member in a transfer position of each photoconductor, thereby to form a full color image.

Since such the tandem type color image forming apparatus has each image forming section of each color, it is advantageous for speed-up.

A conventional tandem type color image forming apparatus will be described below.

FIG. 7 is a diagram showing a state in which a conventional process cartridge protective member is to be attached. In conveyance and storage of process cartridge 2 to 5, by the continuous pressure-contact state between the developing roller 2b to 5b and the photoconductor drum 2a to 5a, contact traces (nip line) of the development roller on a pressure-contact part of photoconductor drum 2a to 5a, and stains on the photoconductor drum 2a to 5a due to oil components of the developing roller 2b to 5b moving from its rubber components are caused. The protective member is attached in order to prevent the contact traces and the stains.

FIG. 8 is a diagram showing a state in which the conventional process cartridge protective member has been attached.

In FIG. 7, reference numerals 14a and 14b are protective members which are inserted into the process cartridge 2 to 5 apart from the center in the longitudinal direction to the left and the right by the predetermined distance, thereby to space the photoconductor drum 2a to 5a and the pressure-contact part (nip part) of the development roller 2b to 5b which are formed in the process cartridge 2 to 5. Further, reference numeral 15 is a photoconductor drum protective cover for protecting the photoconductor drum 2a to 5a exposed to an opening part of the process cartridge 2 to 5. The protective members 14a and 14b are attached in two positions which are right and left symmetrical in order to space the photoconductor drum 2a to 5a and the development roller 2b to 5b uniformly in the axial direction.

FIG. 9 is a diagram showing a state in which another conventional process cartridge protective member is to be attached. This process cartridge protective member has a size covering the nearly entire region in the longitudinal direction of the process cartridge 2 to 5. FIG. 10 is a diagram showing a state in which another conventional process cartridge protective member has been attached. Further, other process cartridge protective members have been also disclosed in JP-A-4-140770 and JP-A-2002-6722.

However, in packing and conveying states of the process cartridge, in case that the process cartridge has been stored for a long period, the pressure-contact state between the developing roller and the photoconductor drum is continued, whereby such a problem is produced that the contact traces (nip line) of the development roller are produced on the pressure-contact part of the photoconductor drum, or the photoconductor drum surface is stained with oil components moving from rubber components of the developing roller. In order to solve such the problem, the countermeasure as described in the above background art has been taken. However, in the conventional constitution, since the members for spacing the photoconductor drum and the development roller must be attached in the right and left two positions in the longitudinal direction of the process cartridge, the two operations must be performed in packing or renewing the process cartridge. If the single space member is formed, it must be formed at the wastefully large size.

Further, in case of a type in which a charge roller is provided in contact with a photoconductor drum, that is, in case of a contact electrification type process cartridge, vibration in conveyance causes reverse rotation of the photoconductor drum, whereby the charge roller is stained, so that bad printing is caused.

### SUMMARY OF THE INVENTION

Therefore, an object of the invention is to provide in image forming apparatus and a process cartridge therefor in that a member for holding space between a photoconductor drum and a development roller and preventing reverse rotation of the photoconductor drum in conveyance and storage of the process cartridge is formed by simple constitution and attached or detached easily.

In order to solve these problems, a process cartridge of the invention includes a photoconductor drum that rotates in the circumferential direction, on which an electrostatic latent image corresponding to a toner image is formed; a development roller that is arranged opposed to the photoconductor drum, and makes the electrostatic latent image formed on the photoconductor drum visible thereby to form a toner image; and an opening part from which the photoconductor drum is partially exposed in the longitudinal direction, wherein the photoconductor drum and the development roller are held in the process cartridge contactably and separatably, and there are provided a first member that is attached to one end in the longitudinal direction of the process cartridge, and holds the photoconductor drum and the development roller spacially, or a second member that is attached to a rotational shaft end of the photoconductor drum to obstruct rotation of the photoconductor drum.

Preferably, a photoconductor drum protective cover that covers the opening part is provided detachably from the process cartridge, the first member is previously attached to the photoconductor drum protective cover, and is attached to or detached from one end part in the longitudinal direction of the process cartridge correspondingly to the attachment and detachment operations of the photoconductor drum protective cover.

Further, splines which are fitted to a photoconductor drive shaft for transmitting the drive force by spline coupling provided for the apparatus body when the process cartridge is attached to the image forming apparatus body is formed at the shaft end of the photoconductor drum, and the second member has a spline fitted to the spline formed at the rotational shaft end of the photoconductor drum. Preferably, regarding a first spline formed at the photoconductor drum in the axial direction, and a second spline formed at the second member, at least one spline part of the first spline is longer than other first spline parts, or at least one spline part of the second spline is longer than other second spline parts.

As described above, according to the invention, in packing or exchanging of the process cartridge, the member for holding space between the photoconductor drum and the development roller can be attached or detached by easy operation, and prevention of the reverse rotation of the photoconductor drum can prevent the stains of the charge roller, so that an effective advantage that good printing quality can be secured can be obtained.

### BRIEF DESCRIPTION OF THE DRAWINGS

FIG. 1 is a schematic diagram showing the constitution of a color image forming apparatus according to an embodiment of the invention.

FIG. 2 is a perspective view showing a process cartridge according to the embodiment of the invention.

FIG. 3 is a sectional view of the process cartridge in FIG. 2.

FIG. 4 is an exploded perspective view of the process cartridge including protective members according to the embodiment of the invention.

FIG. 5 is a perspective view showing a state in which the protective members according to the embodiment of the invention are being attached.

FIG. 6 is a detailed diagram showing a second member for preventing reverse rotation of a photoconductor drum according to the embodiment of the invention, and an end part of a photoconductor drum drive shaft.

FIG. 7 is a diagram showing a state in which a conventional process cartridge protective member is to be attached.

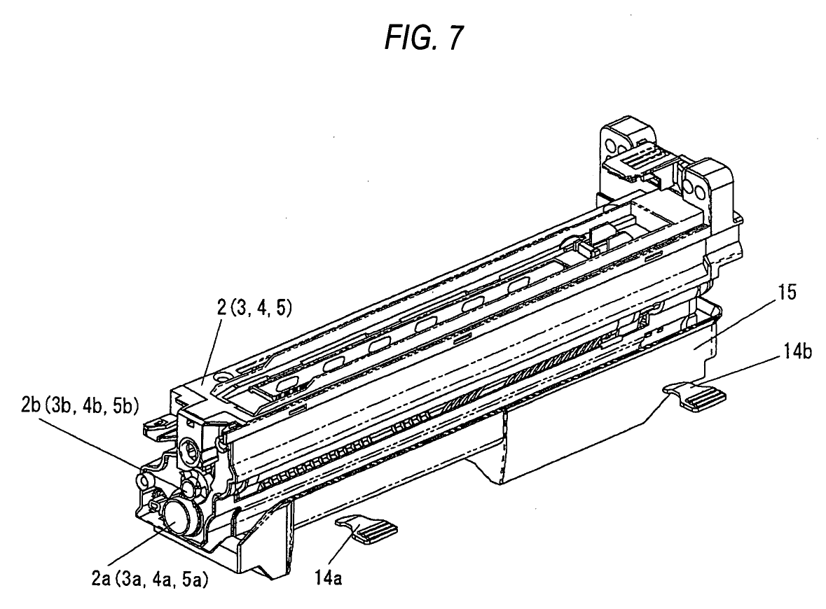

FIG. 8 is a diagram showing a state in which the conventional process cartridge protective member has been attached.

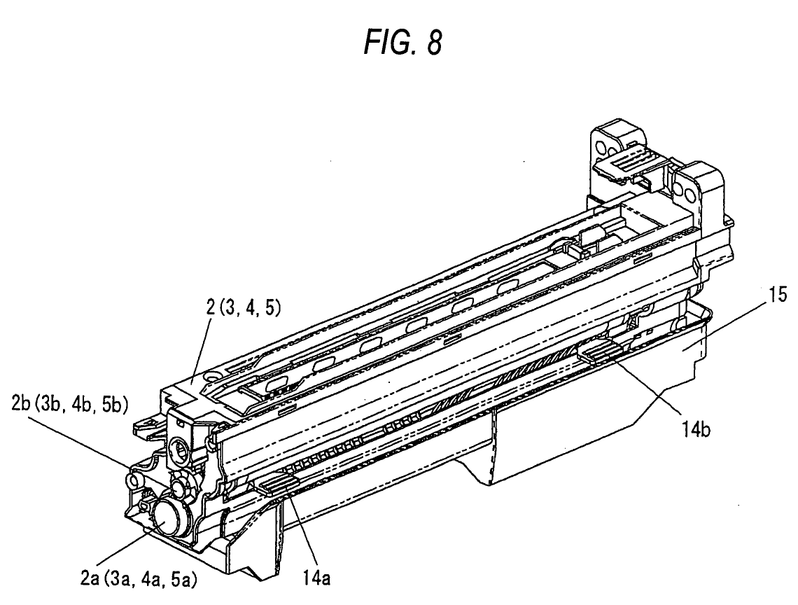

FIG. 9 is a diagram showing a state in which another conventional process cartridge protective member is to be attached.

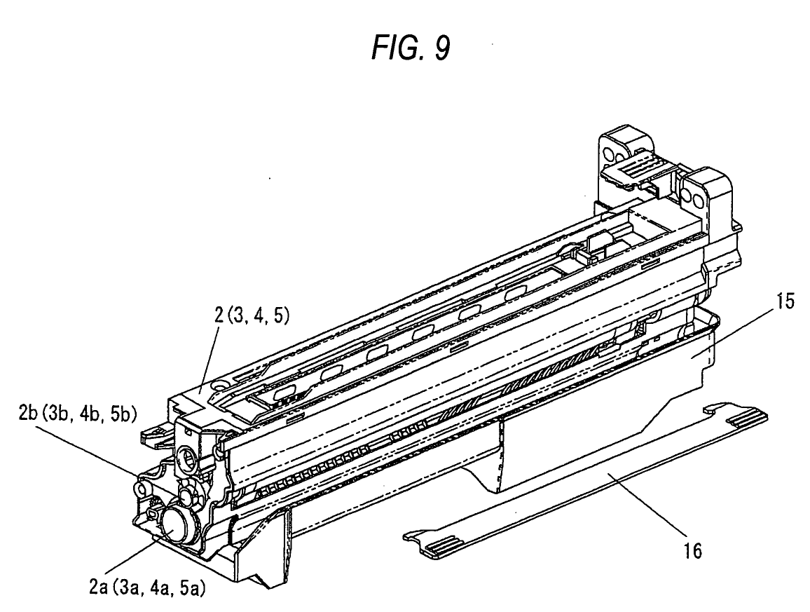

FIG. 10 is a diagram showing a state in which another conventional process cartridge protective member has been attached.

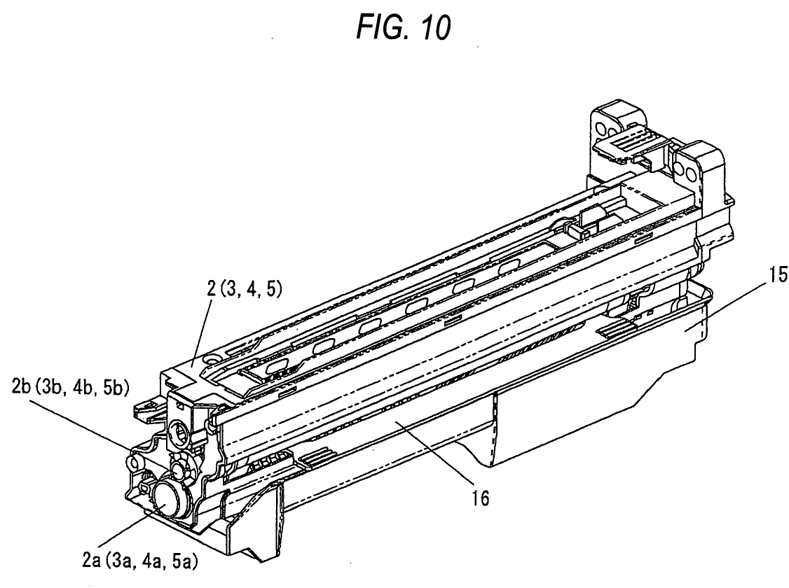

### DETAILED DESCRIPTION OF THE PREFERRED EMBODIMENTS

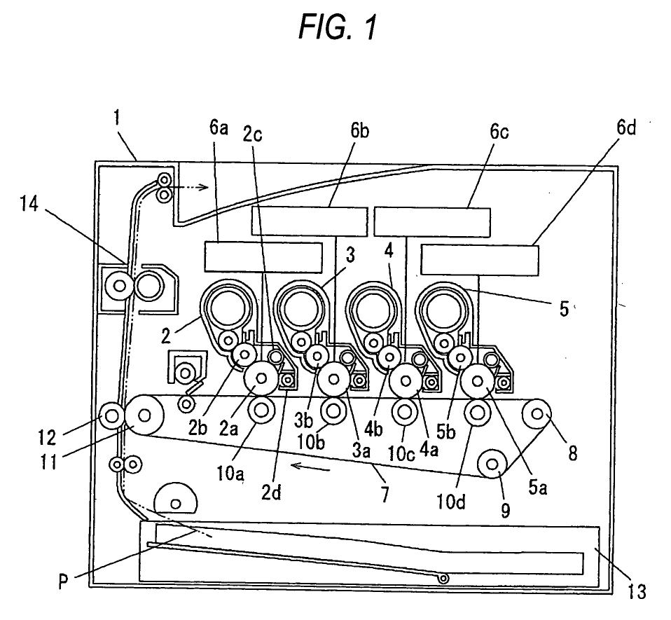

A first embodiment of the invention will be described with reference to FIGS. 1 to 6. In these drawings, the same members are denoted by the same reference numerals, and the overlapped description is omitted.

### First Embodiment

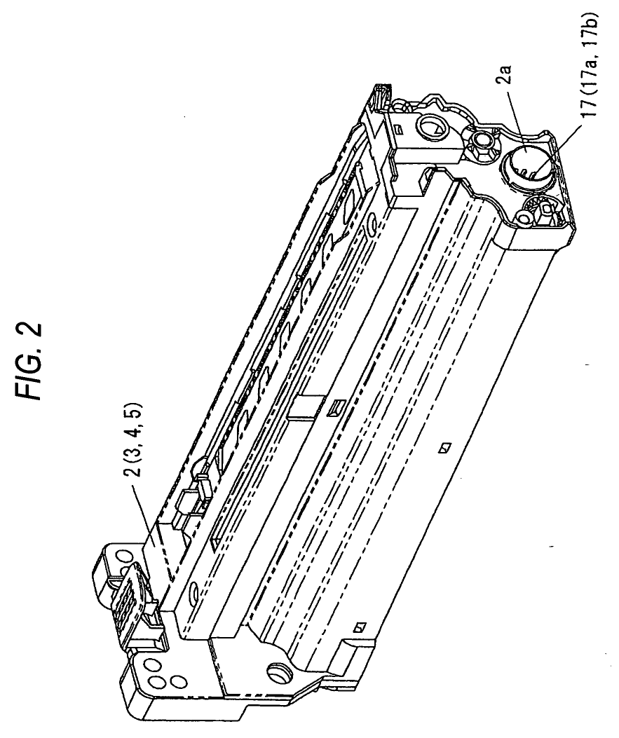

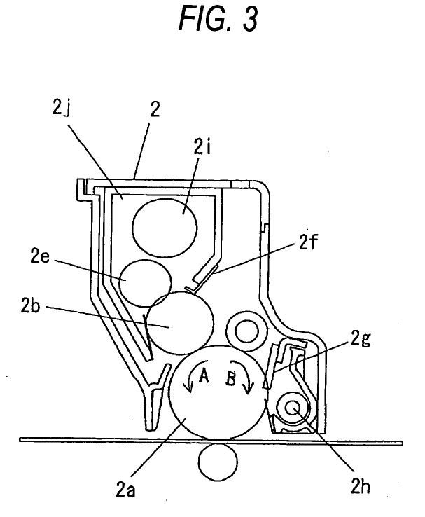

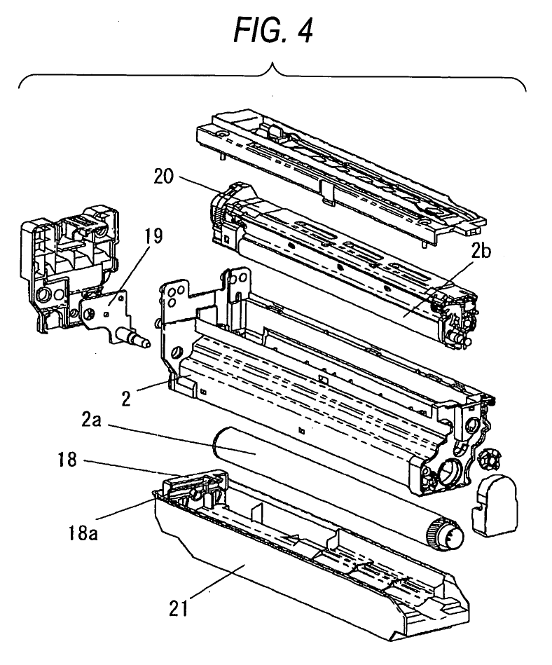

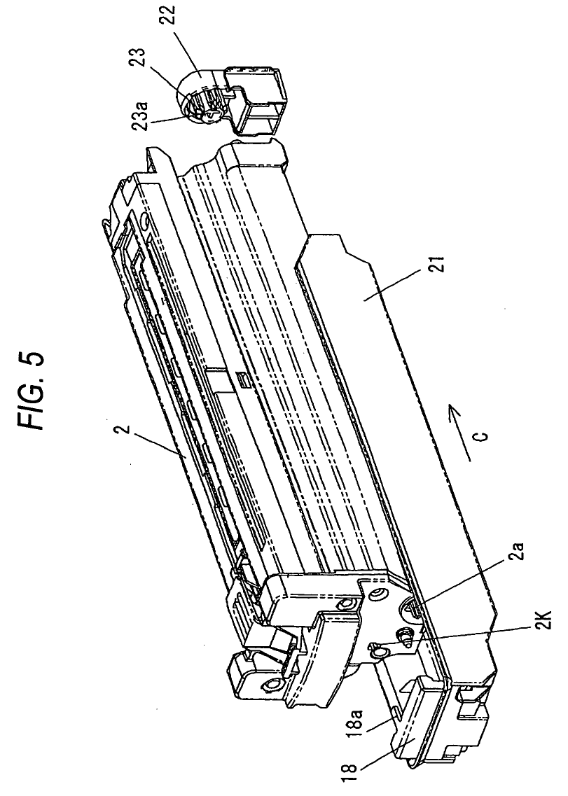

FIG. 1 is a schematic diagram showing the constitution of a color image forming apparatus according to an embodiment of the invention, FIG. 2 is a perspective view showing a process cartridge according to the embodiment of the invention, FIG. 3 is a sectional view of the process cartridge in FIG. 2, FIG. 4 is an exploded perspective view of the process cartridge including protective members according to the embodiment of the invention, and FIG. 5 is a perspective view showing a state in which the protective members according to the embodiment of the invention are being attached.

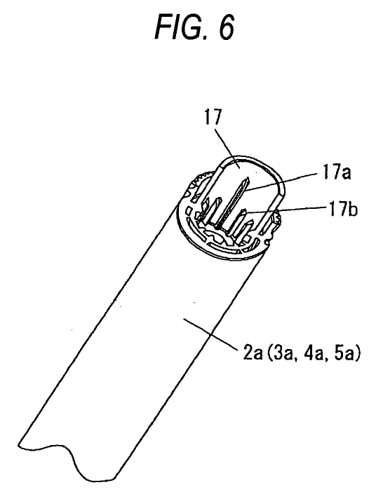

FIG. 6 is a detailed diagram showing a second member for preventing reverse rotation of a photoconductor drum according to the embodiment of the invention, and an end part of a photoconductor drum drive shaft.

In FIG. 1, in a main body 1 of the color image forming apparatus, process cartridges 2, 3, 4, and 5 for respectively forming a toner image of each color of yellow (Y), magenta (M), cyan (C), and black (K) are detachably arranged in order. Correspondingly to these process cartridges 2 to 5, exposing devices 6a, 6b, 6c, and 6d are provided respectively.

The process cartridge 2 to 5 includes a photoconductor drum (photoconductor) 2a, 3a, 4a, 5a that is an image bearing member provided rotatably; a development roller (development means) 2b, 3b, 4b, 5b which causes toner supplied from a toner tank to adhere onto the photoconductor drum 2a to 5a on the peripheral surface of which an electrostatic latent image has been formed by irradiation of laser beams from an exposing device 6a to 6d, and makes the electrostatic latent image visible as a toner image; a charge roller 2c, 3c, 4c, 5c; and a toner exhausting screw 2d, 3d, 4d, 5d.

The photoconductor drums 2a, 3a, 4a, and 5a rotating in the circumferential direction are arranged in alignment so that their rotation axes become parallel to one another. FIG. 3 is a diagram showing a section of the process cartridge 2. Inside the other process cartridges 3 to 5, each element is arranged similarly.

In FIG. 3, reference numeral 2e is a developer supply roller for supplying developer in a developer housing 2j to the development roller 2b. Reference numeral 2f is a doctor blade which forms a fixed thin layer of the developer supplied by the developer supply roller 2e on a surface of the development roller. Reference numeral 2g is a cleaning blade which collects the developer remaining on the photoconductor drum 2a after first bias transfer and cleans the photoconductor drum 2a, and reference numeral 2h is a waste toner transporting screw for transporting the developer collected by the cleaning blade 2g to a waste toner box (not shown) provided separately. Reference numeral 2i is an agitator which agitates and transports the developer in the developer housing 2j.

In the thus constituted process cartridge 2, development bias is applied between the development roller 2b and the photoconductor drum 2a, and a supply roller bias is applied between the developer supply roller 2e and the development roller 2b. Further, the photoconductor drum 2a is rotation-driven in the direction of an arrow A during an image forming operation.

As shown in FIGS. 2 and 6, at the inner circumference of one end of the photoconductor drum 2a, a first spline 17 having plural tooth parts 17a and 17b extending axially is formed. This first spline 17 is, when the process cartridge 2 to 5 is attached to the image forming apparatus body, originally fitted to a gear part (not shown) formed at the periphery of each photoconductor drive shaft and used in order to transmit the drive force from the apparatus body.

In FIG. 4, reference numeral 18 is a non-drive transmission side end part of the process cartridge 2, and it functions as a first protective member having a tongue part 18a.

The tongue part 18a is provided, protruded from the non-drive transmission side end part 18 in the axial direction of the photoconductor drum 2a. The tongue part 18a is inserted between a rotational shaft support member 19 that rotation-supports the photoconductor drum 2a and a unit 20 into which the development roller 2b is built, thereby to act so as to space the support member 19 and the unit 20.

FIG. 5 shows the state where a photoconductor drum protective cover 21 is to be attached to the process cartridge 2. The photoconductor drum protective cover 21 to which the first protective member 18 has previously attached is slid from the non-drive transmission side end part of the process cartridge 2 in the direction of an arrow C so as to cover the opening part (not shown) thereby to be attached to the process cartridge 2. In cooperation with this attachment operation, the tongue part 18a formed in the first protective member 18 is inserted into a hole part 2k of the process cartridge 2, thereby to enter between the rotational shaft support member 19 that rotation-supports the photoconductor drum 2a and the unit 20 into which the development roller 2b is built and act so as to space the support member 19 and the unit 20. Hereby, the photoconductor drum 2a and the development roller 2b are kept in the spaced state.

Here, in this embodiment, the first protective member 18 and the photoconductor drum protective cover 21 are constituted separately, and the first protective member 18 is previously attached to the photoconductor drum protective cover 21. However, they may be formed integrally as components of the invention.

Next, in FIG. 5, reference numeral 22 is a second protective member which is attached to a drive transmission side end part of the process cartridge 2, and acts so as to obstruct rotation of the photoconductor drum 2a. As shown in FIG. 6, at the inner circumference of one end of the photoconductor drum 2a, the first spline 17 having the plural tooth parts 17a and 17b extending axially is formed. In the second protective member 22 shown in FIG. 5, a second spline 23 is formed so as to fit to this first spline 17.

As shown in FIG. 6, of the plural tooth parts 17a and 17b of the first spline 17 formed at each photoconductor drum 2a to 5a, the partial tooth part 17a (in this embodiment, a single tooth part 17a is shown) is longer axially than the other tooth parts 17b.

In this embodiment, though only the single tooth part 17a of the first spline 17 is longer than the other tooth parts 17b, more than two tooth parts may be longer. Namely, the length of at least one tooth part 17a may be different from the lengths of the other tooth parts 17b and may be longer.

Further, the partial tooth part 17a of the first spline 17 is not longer than the other tooth parts 17b, but the partial tooth part 23a of the second spline 23 may be longer. Alternatively, in both tooth parts 17a and 23a of the first spline 17 and the second spline 23, the partial tooth parts 17a and 23a may be made longer so as to be different in the axial length from the other tooth part 17a and 23a.

Further, at an end part of each tooth part 17a, 17b, 23a, a taper is provided in the axial direction and the rotational direction so that fitting can be performed smoothly even in case that the tooth parts come into contact with each other when the second protective member 22 is attached to the process cartridge 2 to 5.

In case that the second protective member 22 has not been attached to the process cartridge yet, the photoconductor drum 2a is kept rotatable. Therefore, due to vibration in conveyance of the process cartridge 2, the photoconductor drum 2a inside the process cartridge 2 rotates reversely in the direction of an arrow B as shown in FIG. 3, so that the charge roller 2C is stained with the toner adhering onto the surface of the photoconductor drum 2a. Therefore, the second protective member 22 is fitted to the first spline 17 formed on the drive shaft end side of the photoconductor drum 2a, and attached to the process cartridge, whereby the rotation of the photoconductor drum 2a is obstructed, and the stains of the charge roller 2C due to the reverse rotation of the photoconductor drum 2a is prevented in conveyance.

Though the invention is applied to the image forming apparatus forming the color image in the above description, it may be applied also to an image forming apparatus forming a monochromatic image.

According to the invention, the following effective advantages are obtained: in packing or exchanging of the process cartridge, the space holding member between the photoconductor drum and the development roller can be attached or detached by the easy operation; by prevention reverse rotation of the photoconductor drum, stains of the charge roller can be avoided; and good printing quality can be secured, so that the invention is useful for the process cartridge used in the electrophotographic image forming apparatus.

This application is based upon and claims the benefit of priority of Japanese Patent Application No. 2003-379474 filed on Nov. 10, 2003, the contents of which are incorporated herein by reference in its entirety.

1. An image forming apparatus comprising:
a photoconductor drum on which an electrostatic latent image corresponding to a toner image is formed;
a development roller which makes the electrostatic latent image on said photoconductor drum visible thereby to form the toner image;
a process cartridge which holds said photoconductor drum and said development roller contactably and separably; and
a protective cover which is attachable to said process cartridge and has a tongue part that enters a nip part between said photoconductor drum and said development roller from the axial direction when the protective cover is attached to said process cartridge thereby to space said photoconductor drum and said development roller.

2. The image forming apparatus according to claim 1, wherein said process cartridge includes an opening part from which said photoconductor drum is partially exposed in the longitudinal direction, and a first member that is attached to one end in the longitudinal direction of said process cartridge, and holds said photoconductor drum and the development roller spacially.

3. The image forming apparatus according to claim 2, wherein a photoconductor drum protective cover that covers said opening part is provided detachably from the process cartridge, and said first member is previously attached to said photoconductor drum protective cover.

4. The image forming apparatus according to claim 3, wherein said first member, correspondingly to the attachment and detachment operations of said photoconductor drum protective cover, is attached to or detached from one end part in the longitudinal direction of said process cartridge.

5. An image forming apparatus comprising:
a photoconductor drum on which an electrostatic latent image corresponding to a toner image is formed;
a development roller which makes the electrostatic latent image on said photoconductor drum visible thereby to form a toner image;
a process cartridge which holds said photoconductor drum and said development roller, and holds the axial end part of said photoconductor drum in the exposed state; and
a protective member which is attached to said process cartridge in a state where it is fitted to said exposed axial end part of said photoconductor drum thereby to inhibit rotation of said photoconductor drum.

6. The image forming apparatus according to claim 5, wherein said process cartridge includes an opening part from which said photoconductor drum is partially exposed in the longitudinal direction, and a second member that is attached to a rotational shaft end of said photoconductor drum to obstruct rotation of said photoconductor drum.

7. The image forming apparatus according to claim 6, wherein a spline which is fitted to a photoconductor drive shaft for transmitting the drive force by spline coupling provided for the apparatus body when the process cartridge is attached to the image forming apparatus body is formed at the shaft end of said photoconductor drum, and said second member has a spline fitted to the spline formed at the rotational shaft end of said photoconductor drum.

8. The image forming apparatus according to claim 7, wherein regarding a first spline formed axially at said photoconductor drum, and a second spline formed at said second member, in one or both of said first spline and said second spline, at least one spline part of said first spline is longer than other first spline parts, or at least one spline part of said second splines is longer than other second spline parts.

9. The image forming apparatus according to claim 7, wherein a leading end of said first spline and a leading end of said second spline are provided respectively with a taper in order to smooth fitting in attachment of the second member.

10. The image forming apparatus according to claim 9, wherein said taper is formed in the axial direction and the rotational direction of said photoconductor drum and said second member.

11. A process cartridge comprising:
a photoconductor drum that rotates in the circumferential direction, on which an electrostatic latent image corresponding to a toner image is formed;
a development roller that is arranged opposed to said photoconductor drum, and makes said electrostatic latent image formed on said photoconductor drum visible thereby to form a toner image; and
an opening part from which said photoconductor drum is partially exposed in the longitudinal direction,
wherein said photoconductor drum and the development roller are held in the process cartridge contactably and separatably; and
said process cartridge further comprising: a first member that is attached to one end in the longitudinal direction of said process cartridge, and holds said photoconductor drum and the development roller spacially and a second member that is attached to a rotational shaft end of said photoconductor drum to obstruct rotation of said photoconductor drum.

12. The process cartridge according to claim 11, wherein a photoconductor drum protective cover that covers said opening part is provided detachably from the process cartridge, and said first member is previously attached to said photoconductor drum protective cover.

13. The process cartridge according to claim 12, wherein said first member, correspondingly to the attachment and detachment operations of said photoconductor drum protective cover, is attached to or detached from one end part in the longitudinal direction of said process cartridge.

14. The process cartridge according to claim 11, wherein a spline which is fitted to a photoconductor drive shaft for transmitting the drive force by spline coupling provided for the apparatus body when the process cartridge is attached to the image forming apparatus body is formed at the shaft end of said photoconductor drum, and said second member has a spline fitted to the spline formed at the rotational shaft end of said photoconductor drum.

15. The process cartridge according to claim 14, wherein regarding a first spline formed axially at said photoconductor drum, and a second spline formed at said second member, in one or both of said first spline and said second spline, at least one spline part of said first spline is longer than other first spline parts, or at least one spline part of said second splines is longer than other second spline parts.

16. The process cartridge according to claim 14, wherein a leading end of said first spline and a leading end of said second spline are provided respectively with a taper in order to smooth fitting in attachment of the second member.

17. The process cartridge according to claim 16, wherein said taper is formed in the axial direction and the rotational direction of said photoconductor drum and said second member.
